(19) United States
(12) Patent Application Publication
(10) Pub. No.: US 2024/0045163 A1
(43) Pub. Date: Feb. 8, 2024

(54) HYBRID TELECOMMUNICATION CABLE

(71) Applicants: CENTRE NATIONAL DE LA RECHERCHE SCIENTIFIQUE, PARIS (FR); I.D.I.L SAS, LANNION (FR)

(72) Inventors: Marc-André GUTSCHER, PLOUMOGUER (FR); Lionel QUETEL, PLEUMEUR BOUDOU (FR)

(73) Assignees: CENTRE NATIONAL DE LA RECHERCHE SCIENTIFIQUE, PARIS (FR); I.D.I.L SAS, LANNION (FR)

(21) Appl. No.: 18/258,818

(22) PCT Filed: Dec. 20, 2021
(86) PCT No.: PCT/EP2021/086699

§ 371 Date: Jun. 22, 2023

(30) Foreign Application Priority Data
Dec. 22, 2020 (FR) FR2013882

(51) Int. Cl. G02B 6/44; G01B 11/16; G01D 5/353

(52) U.S. Cl. CPC G02B 6/4416; G02B 6/4427; G02B 6/4432; G01B 11/16; G01D 5/35361

(57) ABSTRACT

A telecommunication cable including a core with a plurality of optical fibres, an inner reinforcement radially arranged around the core, the inner reinforcement having a plurality of steel wires, an intermediate sheath arranged radially between the core and the inner reinforcement, and a protective sheath made of polymer material arranged radially around the inner reinforcement. The cable further includes at least one optical fibre sensor arranged between the core and the protective sheath.

### TECHNICAL FIELD

The present invention relates to a telecommunications cable, especially a submarine telecommunications cable. It also relates to a method for measuring mechanical deformations undergone by such a telecommunications cable.

The field of the invention is, but not limited to, that of telecommunications.

### BACKGROUND

Optical fibres can be used to implement detectors for various physical quantities. As a measurement light pulse propagates through an optical fibre, light backscattered at scattering sites can be used to detect deformations, movements or vibrations of the fibre.

Such sensing optical fibres are especially useful for monitoring the degree of wear in electrical power cables. Such cables can, for example, connect floating offshore facilities, such as offshore wind turbines, to land-based facilities. These submarine cables are especially subject to the more or less permanent movement transmitted by waves. To monitor these electrical cables, one or more sensing optical fibres can be inserted into the cable to track and detect its movements and stresses.

Another application for sensing optical fibres is seismic monitoring. For this, terrestrial or submarine telecommunications cables are used to detect slow movements of the ground or seabed. In this case, one or more optical fibres dedicated to the transmission of telecommunication data are also used to transmit measurement pulses.

Techniques implemented to carry out such monitoring operations are of the reflectometry and laser interferometry type and include, for example, DAS (distributed acoustic sensing) and FMI (Frequency Metrology Interferometry). However, any use of telecom fibres for DAS or FMI reduces the cable bandwidth. This can lead to a risk of compromising security or confidentiality of the telecoms data being transmitted. Thus, as a general rule, telecom operators do not allow access to their cables for scientific or fundamental research purposes.

The object of the invention is to provide a telecommunications, especially submarine, cable which can overcome these drawbacks.

### SUMMARY

A purpose of the present invention is to provide a telecommunications cable that can be used within the scope of scientific research without compromising security of the telecommunications data being transmitted.

Another purpose of the present invention is to provide a telecommunications cable enabling the mechanical integrity and state of health thereof to be monitored.

It is a further purpose of the present invention to provide a telecommunication cable which can be used within the scope of seismic monitoring.

At least one of these purposes is achieved with a telecommunications cable, especially a submarine cable, comprising:
a core comprising a plurality of optical fibres,
an internal reinforcement radially arranged around the core, the internal reinforcement comprising a plurality of steel wires,
an intermediate sheath radially arranged between the core and the internal reinforcement, and
a protective sheath of polymer material radially arranged around the internal reinforcement,
   the cable further comprising at least one sensing optical fibre arranged between the core and the protective sheath.

The telecommunications cable according to the present invention is a hybrid cable comprising both optical fibres in the core, dedicated to telecommunications, as well as at least one sensing optical fibre arranged between the core and the protective sheath. This at least one sensing optical fibre is an additional optical fibre which is not intended for the transmission of telecommunication data, but solely for a sensor function.

The arrangement of the sensing fibre both outside the core and inside the protective sheath provides proper protection of the sensing fibre against forces imposed on the telecommunications cable (bending, handling of the cable, possible shocks, etc.), while keeping good sensitivity of the sensing fibre for sensing the stresses and strains of the cable.

The integration of one or more sensing optical fibres in a telecommunication, especially submarine, cable, opens up a vast field of applications, based on the detection of slow or rapid deformations of the cable as well as any damage. These measurements can be summarised as environmental measurements, relating to the environment of the cable.

In particular, such a cable makes it possible to carry out monitoring or measurements in places that are not otherwise accessible, especially for seismic monitoring or for observing the movement of the seabed. It is also possible to control and monitor the state of health of the telecommunications cable, that is to follow any progressive degradation over time, and to detect any voluntary or involuntary external degradation. Any such degradation may compromise integrity of the cable and/or confidentiality of the data carried.

The telecommunications cable according to the invention makes it possible to completely decouple transmission of telecom data from environmental measurements of the cable.

According to an advantageous embodiment, the at least one sensing optical fibre can be arranged in a metal tube, the metal tube forming part of the internal reinforcement.

In this case, the sensing optical fibre is particularly well protected from any mechanical degradation. The construction of the cable is only slightly modified compared with a standard cable.

According to an embodiment, at least two sensing optical fibres are arranged in a metal tube, the metal tube forming part of the internal reinforcement.

The presence of at least two sensing fibres provides redundancy in the event of any failure of one of the sensing fibres.

According to a first example, the sensing optical fibres can be tightly arranged against each other, according to a so-called tightly bound configuration.

The tightly bound configuration is particularly well adapted for using the BOTDR (Brillouin Optical Time Domain Reflectometry) technique.

The BOTDR technique is particularly adapted for detecting the deformation of the seabed due to the activity of submarine faults, as well as for establishing and monitoring the state of health of the telecommunications cable itself.

The BOTDR technique makes it possible especially to observe changes that are abrupt or progressive/slow (e.g. in the order of a few centimetres per day, per month or per year). Generally speaking, BOTDR makes it possible to measure changes at base frequencies of less than 1 Hz.

This is called tightly bound configuration.

According to a second example, the sensing optical fibres can be loosely arranged with respect to each other, according to a so-called loosely bound configuration.

The loosely bound configuration is particularly well adapted for using the DAS (distributed acoustic detection) or FMI (frequency metrology interferometry) technique.

DAS and FMI techniques are particularly adapted for seismic monitoring. In this way, it is possible to detect earthquakes taking place at great distances, for example several hundred kilometres from the coast, or in places where there are no seismological stations. Seismic monitoring and the performance of seismic warning systems can therefore be improved.

DAS technique also makes it possible to monitor the telecommunications cable itself, by detecting involuntary degradations and/or deliberate intrusions.

DAS and FMI techniques make it possible especially to observe rapid changes, for example strains shorter than one second, that is with a frequency of >1 Hz).

This is called loosely bound configuration.

According to an advantageous embodiment, at least two sensing optical fibres can be tightly arranged against each other, according to the so-called tightly bound configuration, in a first metal tube, and at least two sensing optical fibres can be loosely arranged with respect to each other, according to the so-called loosely bound configuration, in a second metal tube. The first and second metal tubes form part of the internal reinforcement, the empty space in the tube in the tightly bound configuration being filled with a material such as a resin or a gel.

This configuration of the telecommunications cable makes it possible to measure deformations and/or slow and rapid changes in the cable with a single cable, using the adapted measurement technique or techniques.

Advantageously, the intermediate sheath may comprise a metal sheath adapted to transmit electrical signals.

Electrical signals are required especially to power repeaters installed at regular intervals along the telecommunications cable.

The metal sheath may be made of copper.

According to an embodiment, the telecommunications cable may further comprise an additional reinforcement radially arranged around the protective sheath, and an additional protective sheath radially arranged around the additional reinforcement.

Such a cable with a double reinforcement is particularly robust and well adapted to protect optical fibres in the core when the cable is deployed in high-risk zones, for example due to heavy human activity (fishing, trawling, etc.).

Advantageously, the steel wires of the reinforcement and/or the tubes containing the sensing optical fibres may be of stainless steel.

This material is not, or only very slightly, subject to corrosion.

According to another aspect of the same invention, a method is provided for measuring mechanical deformations undergone by a telecommunications cable according to any of the preceding claims, comprising the following steps of:
providing, by a laser source, a laser pulse;
injecting, by an interrogator, the laser pulse into the at least one sensing optical fibre of the telecommunication cable;
detecting, by the interrogator, an optical signal representing the light intensity of the pulse backscattered in the at least one sensing optical fibre; and
determining, by the interrogator, a mechanical deformation undergone by the cable from the optical signal.

Mechanical deformations undergone by a telecommunications cable, especially a submarine cable, may include elongations and especially axial compressions. Deformations may be due to natural causes (earthquake, submarine landslide or other movement of the seabed, etc.), involuntary anthropogenic stresses (trawling, ship anchor, etc.) or even voluntary intrusions (espionage). Cable deformation can be slow or rapid. Within the scope of the present description, the term “mechanical deformation” can also mean damage or any other mechanical modification of the cable.

These deformations may all be detrimental to the proper functioning of the telecommunication cable.

The at least one sensing fibre present in the telecommunications cable makes it possible to track the state of health of said cable and to monitor the environment of the cable.

### BRIEF DESCRIPTION OF THE FIGURES

Further advantages and characteristics will become apparent upon examining the detailed description of examples in no way limiting, and the appended drawings in which:

FIG. 1 is a schematic representation of a non-limiting exemplary embodiment of a telecommunications cable according to the invention, in a transverse cross-section view;

FIG. 2 is a schematic representation of another non-limiting exemplary embodiment of a telecommunications cable according to the invention, in a transverse cross-section view; and

FIG. 3 is a schematic representation of a cable according to the present invention coupled to an interrogator.

### DETAILED DESCRIPTION

It is understood that the embodiments described below are by no means limiting. It is especially possible to contemplate alternatives to the invention comprising only a selection of the characteristics described hereinafter isolated from the other characteristics described, if this selection of characteristics is sufficient to confer a technical advantage or to differentiate the invention from prior art. This selection comprises at least one preferably functional characteristic without structural details, or with only part of the structural details if this part alone is sufficient to confer a technical advantage or to differentiate the invention from the state of prior art.

In particular, all the alternatives and all the embodiments described may be combined with one another if there is nothing technically opposed to such combination.

In the figures, elements common to several figures may retain the same reference.

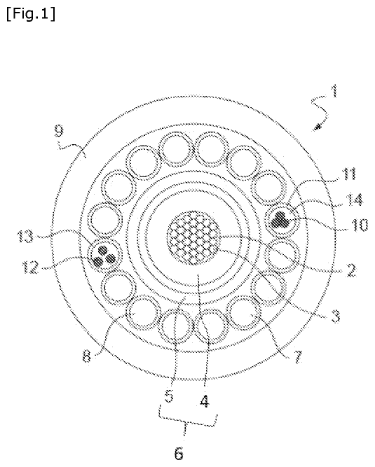

FIG. 1 is a schematic representation of an exemplary embodiment of a submarine telecommunication cable, seen in a transverse cross-section view, according to an embodiment of the invention.

The cable 1 comprises a core 2 with a plurality of optical fibres 3. These optical fibres 3 are dedicated to the transmission of data for telecommunications.

The core 2 is surrounded by a gel sheath 4 for mechanical protection of the optical fibres 3 and water impermeability. The gel layer 4 is surrounded by a copper sheath 5. This metal sheath 5 allows electrical current to be transmitted. The gel sheath 4 and the metal sheath 5 form an intermediate sheath 6.

A reinforcement 7 is radially arranged around the intermediate sheath 6. The reinforcement 7 protects the optical fibres from mechanical stress and gives the cable its mechanical stability.

In the embodiment represented in [FIG. 1], the reinforcement 7 consists of a ring-shaped arrangement of a plurality of steel wires 8. Preferably, the wires are of stainless steel.

Finally, a protective sheath 9 made of polymer material is radially arranged around the reinforcement 7, constituting the external, impermeable barrier of the cable 1.

The cable 1 according to the embodiment shown in [FIG. 1] also comprises sensing optical fibres. Three sensing fibres 10 are tightly arranged against each other in a metal tube 11 forming part of the reinforcement 7. A further three sensing fibres 12 are loosely arranged relative to each other in a further metal tube 13 also forming part of the reinforcement 7.

In the tightly bound configuration of the sensing fibres 10, the empty space in the metal tube 11 is filled with a resin or gel 14.

The metal tubes 11, 13 are preferably made of stainless steel, like the other wires of the reinforcement 7.

Of course, other configurations for the arrangement and/or number of sensing optical fibres are possible.

For example, it is possible to increase the number of fibres in the tube (but three is probably an ideal number).

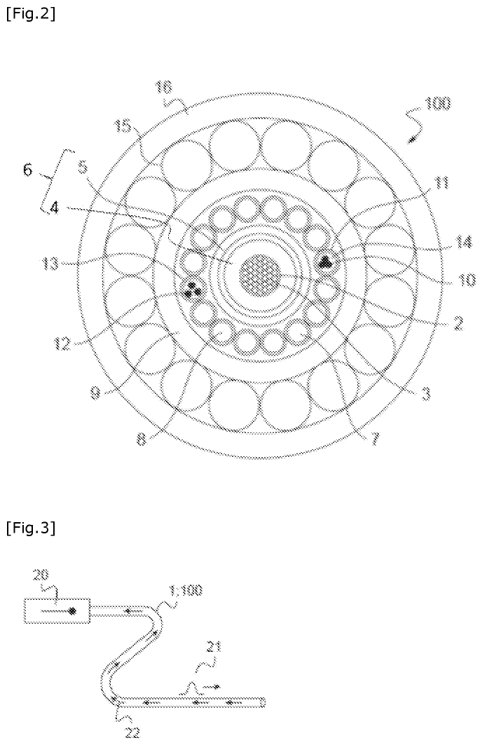

FIG. 2 is a schematic representation of another example of a submarine telecommunication cable, seen in a transverse cross-section view, according to another embodiment of the invention.

The cable 100 according to the embodiment represented in [FIG. 2] comprises all the elements of the cable 1 according to the embodiment of [FIG. 1].

The cable 100 of [FIG. 2] further comprises a second reinforcement 15 radially arranged around the metal sheath 5. This additional reinforcement 15 is, like the internal reinforcement 7, made up of a plurality of steel wires arranged in a ring.

An additional protective sheath 16 of polymer is radially arranged around the additional reinforcement 15.

The protective sheath or sheaths may especially be made of polyethylene.

The diameter of the cables according to the embodiments of FIGS. 1 and 2 is approximately between 10 and 20 mm.

An exemplary embodiment of a measurement method according to the invention will be described below with reference to FIGS. 1 to 3. The measurement method makes it possible to measure mechanical deformations undergone by a telecommunications cable according to the invention, for example by cables according to the embodiments described with reference to FIGS. 1 and 2.

FIG. 3 shows an interrogator 20 to which a telecommunications cable 1, 100 is coupled. The interrogator comprises a laser source as well as a light sensor.

A laser pulse 21 is coupled into each sensing optical fibre of the cable at its proximal end. The pulse 21 propagates in the sensing fibre and is partially backscattered by scattering sites in the fibre. The backscattered light 22 interferes with light reflected from the distal end of the sensing fibre.

The backscattered light 22 is detected by the sensor of the interrogator 20. The signal sensed includes the signature of a scattering site, the time course of which can then be observed. It is thus possible to detect or determine a mechanical deformation undergone by the cable from the optical signal. For this, the interrogator 20 is equipped with a processor or equivalent.

In practice, tens of thousands or tens of millions of ultra-short pulses (lasting a few nanoseconds) can be injected into each sensing fibre of the cable.

According to an embodiment, the ends of two sensing fibres can be welded together at the distal end of the cable. A laser pulse can be injected into one of the sensing fibres, and both fibres can be simultaneously interrogated.

This embodiment is in particular adapted for short distances covered (<50 km). It enables the measurement to be duplicated, this redundancy increasing reliability of the measurements.

The interrogator 20 may be of the DAS type. In this case, the interrogator is coupled to one or more sensing fibres in a tightly bound configuration.

The interrogator 20 may also be of the BOTDR type.

Finally, the interrogator 20 may also be of the FMI type.

Of course, it is possible to couple more than one interrogator to the sensing optical fibres of the cable. For example, a DAS interrogator can be coupled to one or more sensing fibres in the loosely bound configuration for seismic monitoring and/or monitoring of the cable to detect voluntary or involuntary degradations. A BOTDR interrogator can be coupled to one or more sensing fibres in the tightly bound configuration for detecting slow deformations of the seabed due to the activity of submarine faults and/or for detecting voluntary or involuntary degradations.

Of course, the invention is not limited to the examples just described and many alterations can be made to these examples without departing from the scope of the invention.

1-11. (canceled)

12. A telecommunications, especially submarine, cable comprising:
a core comprising a plurality of optical fibres,
an internal reinforcement radially arranged around the core, the internal reinforcement comprising a plurality of steel wires,
an intermediate sheath radially arranged between the core and the internal reinforcement, and a protective sheath of polymer material radially arranged around the internal reinforcement, wherein the cable further comprises at least one sensing optical fibre arranged between the core and the protective sheath.

13. The cable according to claim 12, wherein the at least one sensing optical fibre is arranged in a metal tube, the metal tube forming part of the internal reinforcement.

14. The cable according to claim 12, wherein at least two sensing optical fibres are arranged in a metal tube, the metal tube forming part of the internal reinforcement.

15. The cable according to claim 14, wherein the sensing optical fibres are tightly arranged against each other, in a so-called tightly bound configuration.

16. The cable according to claim 14, wherein the sensing optical fibres are loosely arranged with respect to one another, in a so-called loosely bound configuration.

17. The cable according to claim 12, wherein at least two sensing optical fibres are tightly arranged against each other, in a so-called tightly bound configuration, in a first metal tube, and at least two sensing optical fibres are loosely arranged with respect to each other, in a so-called loosely bound configuration, in a second metal tube, the first and second metal tubes, forming part of the internal reinforcement, the empty space in the tube in the tightly bound configuration being filled with a resin or gel.

18. The cable according to claim 12, wherein the intermediate sheath comprises a metal sheath adapted to transmit electrical signals.

19. The cable according to claim 12, further comprising an additional reinforcement radially arranged around the protective sheath, and an additional protective sheath radially arranged around the additional reinforcement.

20. The cable according to claim 12, wherein the steel wires are of stainless steel.

21. The cable according to claim 13, wherein the metal tube is of stainless steel.

22. A method for measuring mechanical deformations undergone by a telecommunications cable according to any of the preceding claims, comprising the following steps of:
providing, by a laser source, a laser pulse;
injecting, by an interrogator, the laser pulse into the at least one sensing optical fibre of the telecommunication cable;
detecting, by the interrogator, an optical signal representing the light intensity of the pulse backscattered in the at least one sensing optical fibre; and
determining, by the interrogator, a mechanical deformation undergone by the cable from the optical signal.
